(19) United States
(12) Patent Application Publication
(10) Pub. No.: US 2025/0269265 A1
(43) Pub. Date: Aug. 28, 2025

(54) INTERACTIVE COLLECTIBLES SUCH AS INTERACTIVE TRADING CARDS AND METHODS OF MANUFACTURING THE SAME

(71) Applicant: Dynamics Inc., Cheswick, PA (US)

(72) Inventors: Jeffrey D. Mullen, Glenshaw, PA (US); James H. Workley, Sevierville, TN (US); Neil J. Martin, Corryton, TN (US)

(21) Appl. No.: 19/063,885

(22) Filed: Feb. 26, 2025

Related U.S. Application Data
(60) Provisional application No. 63/558,078, filed on Feb. 26, 2024.

(51) Int. Cl. A63F 1/02; A63F 1/18

(52) U.S. Cl. CPC A63F 1/02; A63F 1/18; A63F 2250/609

(57) ABSTRACT

A collectible, such as an interactive trading card such as an interactive sports card and/or an interactive gaming card, may be fabricated with an electronics package including one or more light sensors. When a pack of trading cards is opened and light shines on an interactive trading card, the light sensor may be activated by the light and an experience may be provided to the user. Such an experience may be, for example, an animation provided on a light emitting diode (LED) display. Multiple animations may be provided by an interactive trading card after on light sensor activation or across multiple light sensor activations in either a pre-determined or a random order. An interactive trading card may include a wireless recharging antenna such that the interactive trading card may be recharged (e.g., by a wireless recharger).

### CROSS-REFERENCE TO RELATED APPLICATION

This application claims the benefit of U.S. Provisional Patent Application No. 63/558,078, titled “INTERACTIVE COLLECTIBLES SUCH AS INTERACTIVE TRADING CARDS AND METHODS OF MANUFACTURING THE SAME,” filed Feb. 23, 2016 (Docket No. D/201PROV), which is hereby incorporated by reference herein in its entirety.

### BACKGROUND OF THE INVENTION

This invention relates to interactive battery-powered collectibles such as interactive trading cards, interactive comic books, interactive figurines, interactive memorabilia, and other types of interactive battery-powered collectibles.

### SUMMARY OF THE INVENTION

Collectibles may be provided that include electronic circuitry such as battery-powered circuitry or non-battery powered circuitry. Collectibles may include, for example, interactive electronic circuitry such that a user can enjoy enhanced collectible experiences while interacting with the collectible. Collectibles may include, for example, trading cards, coins, stamps, figurines, comic books, or any other type of collectible.

For example, an interactive trading card may include electronic circuitry with a light sensor and display such as a display of light-emitting diodes. A trading card may include one or more than one display animations stored in a memory of the interactive trading card. When a trading card pack is opened and the interactive trading card is removed from the sealed pack, the light sensor may be initiated when light interacts with the light sensor and one or more stored animations may be autonomously played on the display. For example, animations may be played in a particular sequence each time the light sensor is triggered and/or animations may be played autonomously each time the light sensor is triggered. As per another example, multiple animations may be played when a light sensor or light sensor array is triggered and these animations may be played in a particular order or in a randomized order.

Accordingly, a user may open a pack of cards having multiple static trading cards and one or more interactive trading cards and when the user exposes one or more of the interactive trading cards to light those trading cards may provide enhanced experiences such as light shows (e.g., via a display such as a display of light emitting diodes), sound shows (e.g., a speaker system having one or more speakers such as diaphragm based speakers), vibrational or tactile shows (e.g., a vibrational system having one or more vibrational elements), and/or any combination of human perceivable experiences.

Accordingly, for example, a trading card insert set may take on a fireworks theme. When a trading card is removed from a sealed pack of cards, light may hit the surface of the card and trigger one or more light sensors in the card. As a result, a fireworks animation may be shown on the display. For example, fireworks may be displayed that launch and move across the display before bursting into multiple firework entrails that then fall and dissipate. As per another example, a trading card insert set may be comprised of several cards that take the theme of an earthquake. As an interactive trading card is removed from the darkness of a sealed pack the card may be triggered by the light sensor and may vibrate at one or more intensities at one or more patterns of vibration to simulate an earthquake. One or more displayed light shows may also be provided (e.g., animations of buildings rumbling and/or breaking apart and falling down). As per another example, a trading card may be exposed to light and a light sensor may trigger causing audible sounds to be generated by the card. For example, one or more sound effects and or musical segments may be placed by the card. Accordingly, for example, if a trading card had a movie theme (e.g., the movie Top Gun), then musical segments or sound effects associated with that movie may be provided. Additionally, for example, speech from a character and/or actor may be provided such as a line of from the movie associated with the trading card.

A display may scroll text such as for example, the amount of power remaining before a battery is depleted. Textual animations may include, for example, instructions to the user and/or textual animations that provide an experience. For example, the trading card of an athlete may provide a display of one or more of the sayings of that athlete. Multiple collectibles may interact one another by sensing the presence of one another (e.g., via one or more antennas as well as sharing information with one another to identify each other. For example, a trading card of particular athlete (e.g., Michael Jordan) may provide a particular set of experiences (e.g., textual animations) and another athlete (e.g., Scottie Pippen) may provide a different set of experiences (e.g., textual animations). When the two trading cards are played in the proximity of one another, the trading cards may identify each other and begin to provide different experiences (e.g., different textual animations). For example, a Michael Jordan card may provide text on Michael Jordan statistics and a Scottie Pippen card may provide text on Scottie Pippen statistics but when the two cards are in the proximity of one another they may each provide the same or different statistics on team statistics and/or player association statistics (e.g., how many championships they won together).

Persons skilled in the art will appreciate that different types of collectibles may interact with one another. For example, a trading card may interact with a comic book and the comic book may provide different animations when a particular trading card or set of trading cards is within the proximity of the comic book.

Interactive electronics for collectibles may include batteries and may include electronics to recharge such batteries. For example, a wireless charging antenna and circuitry may be provided in an electronics package such that a battery may be recharged wirelessly. In doing so, for example, a wireless battery recharger may recharge a battery without, for example, physically touching the collectible and/or electronics. Wired power connection(s) may also be provided such that a wire-based charger may be utilized to charge an interactive collectible (e.g., via a wall plug).

Persons skilled in the art will appreciate that a trading card may be a trading card game card such that cards may be played as part of a game. Accordingly, for example, a display may be provided that provides randomized game elements such as randomized dice rolls (e.g., a random 20 sides dice roll) and/or randomized game metrics (e.g., randomized power levels, defense levels, hit point levels, randomized abilities). Accordingly, interactive trading cards may be played during a game and the game may have a randomized element to increase the games playability. Trading card game cards may also interact with one another so, for example, gaming cards may provide animations when they interact (e.g., animations simulating attacking, defending, battling).

One or more light sensors may be sampled for light and such samples may be averaged together over a period of time to determine if, for example, a threshold is met to initiate interactive elements (e. g., display, sound, and/or tactile elements). A determined activation may, for example, be utilized to trigger an interactive element after, for example, a pre-determined delay. For example, a delay of more than 1 second, more than 2 seconds, more than 3 seconds, or any type of delay may be provided. Such a delay may be utilized for example, to assist a user in removing a card fully from a sealed pack or from a stack of cards before the interactive experience is started. One or more experiences (e.g., animations of light) may have the same or different durations of play. The duration may be changed by the interactive trading card (e.g., animations may be shortened or may be played faster as a battery is determined to be running low past a particular threshold in order to preserve energy).

To conserve and/or optimize energy, light sensor(s) may be sampled periodically. A microprocessor of the collectible may be placed into different sleep modes to conserve and/or optimize power. For example, a microprocessor may be placed into a particular sleep mode for a period of time (e.g., at least 1 second, at least 2 seconds, at least 3 seconds) and then one or more light sensors may be sampled. If the samples and/or average of samples do not pass certain conditions (e.g., thresholds) the microprocessor may be placed back into the particular sleep mode for another duration of time before waking up out of that particular sleep mode and checking the light sensor(s) again for activation. An oscillator, such as a crystal, may be utilized, for example, as part of keeping time and part of waking up a microprocessor out of sleep mode. Persons skilled in the art may appreciate that a microprocessor may include an internal oscillator (e.g., real time clock circuit) but that particular sleep modes may be utilized with an external oscillator (e.g., crystal) to conserve energy dissipation. Animations may be provided for a particular time when a collectible determined an activation. The collectible may then be placed into a sleep mode while still in the presence of light. In doing so, for example, a re-trigger event may be a transition from a light sensing state to a dark sensing state and back to a light sensing state. In doing so, for example, a collectible may be left in light and the collectible may experience only a single light triggering event before going into a sleep mode such that power is conserved.

Persons skilled in the art will appreciate that numerous types of sensors may be utilized in addition to, or instead of, one or more light sensors. For example, capacitive sensors may be utilized to determine the presence, for example, of a hand on a collectible. As per another example, inductive sensors may be utilized and inductive elements may be placed in multiple collectibles such that removing a collectible from a stack of collectibles creates an activation event via a detected change in an inductive sensor.

Displays may be, for example, any type of display such as a liquid crystal display, light emitting diode display, organic light emitting diode display, bi-stable display (e.g., electronic ink display) or any other type of display. A light emitting diode display may be provided, for example, by providing rows of light emitting diodes. A multiplexer may be utilized to switch between the rows. Another circuitry (e.g., multiplexer) may be utilized to switch between the columns. Accordingly, for example, an array of rows and columns of light emitting diodes may be controlled such that individual light emitting diodes are iteratively determined whether or not to be activated by stepping through rows of light emitting diodes and stepping through each light emitting diode in a row. Accordingly, a user may perceive an animation when, for example, no more than a single, or a sub-set of light emitting diodes, are activated and providing light at any one time. Light emitting diodes may be controlled, for example, to have a duty cycle so they are ON a particular period of time an OFF a particular period of time (e.g., they cycle between ON and OFF at a faster rate than is perceivable by a human). The intensity of light emitting diodes may be changed and, in doing so, for example, the amount of power may be changed. Accordingly, for example, the first animation of a sequence of animations may have a particular intensity while another animation has a different intensity of light. As per another example, different animations may have different intensities. Changing the duty cycle, for example, may change the amount of light provided by a light emitting diode.

LEDs in an array may have the same color and/or different colors and LEDs in an array may be single color LEDs and/or multiple color LEDs. More than one displays (e.g., LED arrays) may be provided on a collectible and different displays may be triggered at different times during a sequence or under different conditions. Collectible rarity may be associated with LED color such that, for example, a serial numbered trading card having a first print run (e.g., 100 copies or less than 100 copies) may be one color while the same trading card (e.g., the same trading card number but with a different color printing) may have a different LED color and have a different print run (e.g., more than 100 copies). In doing so, the rarity of a trading card may be enhanced and, for example, the collectability of that trading card may be enhanced.

A collectible such as an interactive trading card may include mechanical buttons and or other types of buttons for receiving manual input. In doing so, for example, a user may interact with an interactive trading card (e.g., to initiate different experiences and/or to initiate different game elements). An interactive collectible, such as an interactive trading card, may have an ON/OFF button so that the user may turn a collectible ON and OFF. A collectible may be manually turned ON and OFF. A collectible may also be autonomously turned ON and OFF. For example, a collectible may autonomously be turned ON and manually turned OFF. A collectible may be manually turned ON and may be autonomously turned OFF (e.g., after a period of time of no manual interaction and/or after a completion of an experience that was manually activated).

Information may be downloaded and/or uploaded from a collectible. A device (e.g., a stationary computer, a portable computer, a portable telephonic device) may interact with the collectible (e.g., via a wire-based or wireless connection) and may download information (e.g., new experiences such as new sound data, new light animation data, new haptic feedback data, new displayed textual data, new game data, new operating software) and may modify information as well as upload information (e.g., usage information, power information, game play data, user inputted data).

Electronics may be laminated (e.g., via a liquid plastic that is cured into a hard plastic such as via a light-based cure (e.g., UV and/or blue band light cure), thermal cure, chemical cure, pressure cure, and/or multiple types of cures. The polymer may be transparent such that, for example, a user can see the electronics through the laminate. In doing so, for example, light sensor(s) in the electronics package may be able to more easily detect and determine light and light emitting diodes in the electronics package may be able to more easily emit light.

Persons skilled in the art will appreciate that the laminated electronics package may be directly printed on (e.g., via a light-based cured polymer printing process) the laminated package. The laminated package may be cut before and/or after printing via a mechanical cutting process and/or a laser cutting process. The laminated package may have cornered edges and/or straight edges.

A laminated electronics package, or any electronics package, may, for example, be placed in an aperture of collectible layer (e.g., a trading card layer). An obverse layer such as, for example, an obverse trading card layer, may be affixed (e.g., via an adhesive) to the obverse side of the layer having the aperture with an electronics package. A reverse layer such as, for example, a reverse trading card layer, may be affixed (e.g., via an adhesive) to the reverse side of the layer having an aperture with an electronics package. The obverse and reverse layers may be pre-printed prior to affixation or may be post-printed after affixation. The printed layers may have ink-based print, cure-based print, and/or additional security elements such as security holograms.

The layer with one or more apertures and/or one or more troughs holding one or more electronics packages (e.g., one or more laminated electronics packages) may be thicker than each of the one or more layers of the collectible (e.g., an obverse layer(s) and/or reverse layer(s)). The layers may be of the same material (e.g., a cardboard or transparent polymer) or the layers may be of a different material (e.g., a middle layer may be cardboard while one or more external layers may be a polymer). One or more apertures may be cut in one or more layers in the proximity of a light sensor such that a light sensor may receive more light. Printing may be lighter or may not be provided in the proximity of one or more light sensors such that the light sensors may receive more light.

Security chips, such as security chips with wireless (e.g., RFID) antennas, may be placed in a collectible item such as in an aperture with the electronics package, inside the laminate with the electronics package, or fabricated as a part in the electronics package such as a fabricated element on a single layer or multiple layer or several layer printed circuit board) when the collectible item is first manufactured, after the item is manufactured but before the item is distributed to end users through a sales channel, and/or placed in an encapsulated case or on a tag for an encapsulation case. Information about the collectible (e.g., a unique identification number) as well as the interactive elements of the collectible (e.g., software revision, hardware revision, and/or experience data) may be stored on the chip. The chip may also be accessed in order to confirm the identity of the collectible as well as access additional information about the collectible (e.g., blockchain data, interactive data, collectible data, manufacturers data, storage data, grading data, appraisal data, authentication data, etc.).

### BRIEF DESCRIPTION OF THE DRAWINGS

The principles and advantages of the present invention can be more clearly understood from the following detailed description considered in conjunction with the following drawings, in which the same reference numerals denote the same structural elements throughout, and in which:

FIG. 1 is an illustration of a collectible item architectures and flow charts constructed in accordance with the principles of the present invention;

FIG. 2 is an illustration of collectible item architectures constructed in accordance with the principles of the present invention;

FIG. 3 is an illustration of a collectible item architectures constructed in accordance with the principles of the present invention;

FIG. 4 is an illustration of a collectible item architectures constructed in accordance with the principles of the present invention;

FIG. 5 is an illustration of a collectible item architecture and flow charts constructed in accordance with the principles of the present invention;

FIG. 6 is an illustration of a collectible item architecture constructed in accordance with the principles of the present invention;

FIG. 7 is an illustration of flow charts constructed in accordance with the principles of the present invention;

FIG. 8 is an illustration of collectible item architectures constructed in accordance with the principles of the present invention;

FIG. 9 is an illustration of a collectible item architecture constructed in accordance with the principles of the present invention;

FIG. 10 is an illustration of a collectible item architecture constructed in accordance with the principles of the present invention;

FIG. 11 is an illustration of a collectible item architecture constructed in accordance with the principles of the present invention;

FIG. 12 is an illustration of collectible item architectures constructed in accordance with the principles of the present invention; and

FIG. 13 is an illustration of flow charts constructed in accordance with the principles of the present invention.

### DETAILED DESCRIPTION OF THE INVENTION

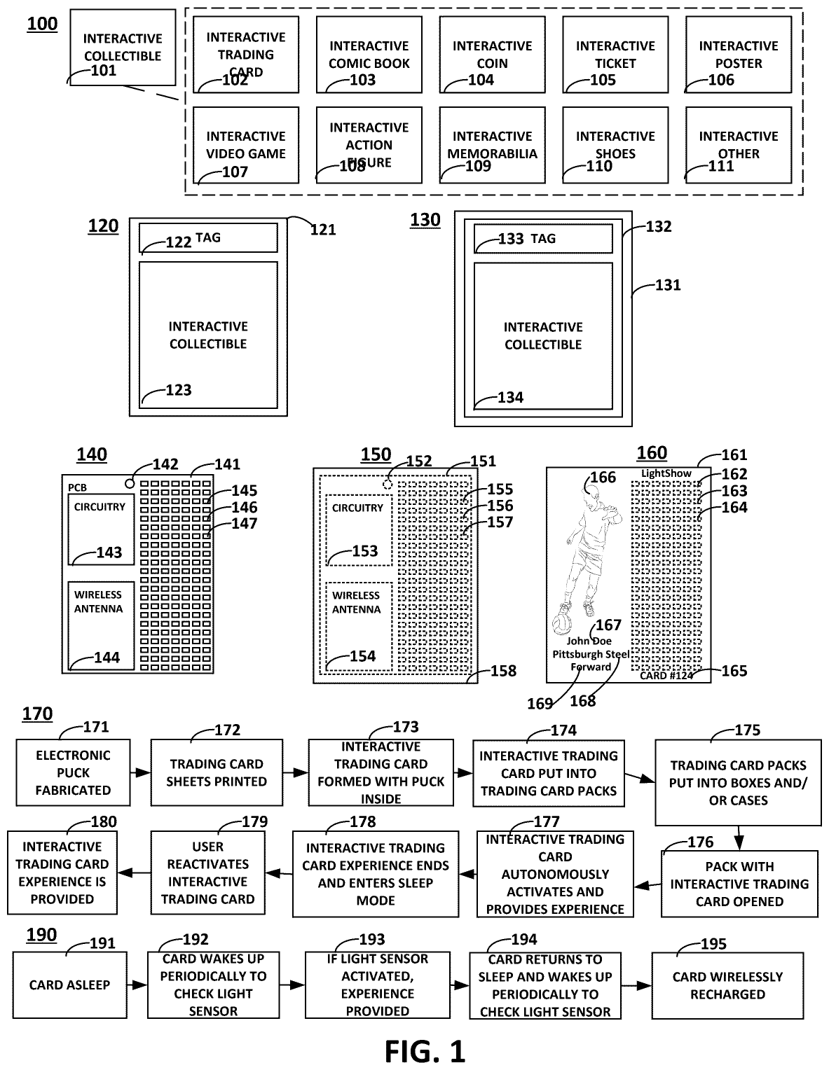

FIG. 1 shows interactive collectible item 101 which may be, for example, any type of item or collectible item such as interactive trading card 102, interactive comic book 103, interactive coin 104, interactive ticket 105, interactive poster 106, interactive video game 107, interactive action FIG. 108, interactive memorabilia 109, interactive shoes 110, or other interactive collectible type 1011.

Interactive collectible 101 may be encapsulated in encapsulation case 120 that may include encapsulation housing 212 with a tag cavity for tag 122 and a collectible cavity for collectible 123. Encapsulation case 120 may be permanently formed by fixing multiple encapsulation case portions (e.g., two, three, four, or more than four) together using, for example, welding (e.g., ultrasonic welding) and/or one or more adhesives (e.g., a chemical, pressure, light cure such as UV cure, temperature, and/or time adhesive). Encapsulation case 120 may be fabricated from one or more transparent materials such as polystyrene, polycarbonate, polyethylene terephthalate, and/or acrylic. Encapsulation case 120 may be fabricated from rigid materials.

Encapsulation case 130 may be fabricated from a rigid transparent housing 131 for housing semi-rigid encapsulation case 132 that may include a first cavity for tag 133 and a second cavity for interactive collectible 134. A semi-rigid encapsulation may be fabricated from multiple portions of semi-rigid material (e.g., 10 mm-14 mm, particularly 12 mm thick polyethylene terephthalate) that are permanently fixed together (e.g., via an adhesive or a bonding such as ultrasonic welding and/or thermal bonding). For example, semi-rigid encapsulation case 132 may include two layers of polyethylene terephthalate where one or two of these layers include, for example, prefabricated cavities for one or more tag(s) and/or collectible(s). The pre-fabricated cavities may be formed, for example, via a heat press and/or a molding process. Persons skilled in the art will appreciate that the corners of any cavity or cavities (e.g., a collectible cavity but not a tag cavity or a collectible cavity and a tag cavity) may be bubbled/extended out so that the corners, for example, of a collectible with 90-degree corners is not physically able to touch the corners of a cavity. Encapsulation case 131 may have a single cavity for encapsulation case 132. Such a single cavity, for example, may be formed, for example, from one or more transparent rigid encapsulation case portions that are fixed together (e.g., ultrasonically welded together) that have a full cavity for a collectible or a part of a cavity for a collectible. For example, one portion of case 132 may have a full cavity for a collectible or two portions of case 132 may each have a portion of a full cavity for a collectible such that, when fixed together, a full cavity is formed.

An autonomous machine may be provided that may permanently destroy an encapsulation case in order to, for example, free an interactive collectible and/or a tag from the encapsulation case without damage. A tag may, for example, be fabricated in a way that is destroyed when attempted to be removed from an encapsulation case. For example, a tag may be permanently fixed to an encapsulation case (e.g., via an adhesive) or may be not be bonded to a cavity of an encapsulation case so the tag can be removed if the case is destroyed. Such an autonomous machine may, for example, cut an encapsulation case using a laser cutting process and/or mechanical cutting process.

An entity may provide a platform for performing value-added services for collectible items such as, for example, manually and/or autonomously receiving interactive collectible items, documenting interactive collectible items, printing informational tags for interactive collectible items, encapsulating collectible items, scanning/providing image capture of collectible items, authenticating interactive collectible items, providing a condition grade for interactive collectible items, providing secure storage in a variety of storage locations such as different levels of security of physical security vaults, providing insurance for the interactive collectible items, appraising collectible items, listing interactive collectible items on marketplaces where the collectible items may be purchased, sold, traded and for other items, and/or auctioned, socially communicated via forums, message boards, email communications, mobile phone text communications, third party website/API pushes, and/or any other type of product and/or service for an item, service, and/or collectible item. In doing so, for example, a user may store a physical item on the platform and the platform may perform all physical activities associated with long-term collecting services so that the user does not have to perform any additional physical interactions with the collectible itself and can provide digital instructions to the platform to perform collecting related actions when the collecting related actions are desired by the user.

Interactive collectible 140 includes printed circuit board 141, light sensor 142, light emitting diode display including light emitting diodes 145, 146, and 147, electronic circuitry 143, and wireless recharging antenna 144. Light sensor 142 may detect light and may initiate a sequence of light emitting diode activations of a display (e.g., a display including light emitting diodes 145, 146, and 147). Wireless recharging antenna 144 may be utilized to charge a battery (not shown) mechanically and electrically coupled to the electronics of collectible 140. Information may also be conveyed to/from collectible 140 from antenna 144 or additional antennas may be included in collectible 140. Persons skilled in the art will appreciate that different antennas may be utilized for different types of communications or features (e.g., a first antenna for wireless power recharging and a second antenna for RFID communications and a third antenna for higher bandwidth communications such as cellular telecommunications). Bluetooth circuitry may also be included, as well as any type of communication circuitry, in order to provide Bluetooth connectivity between a collectible and another device (e.g., another collectible and/or a computer such as a stational computer, portable computer, or a portable telephonic device).

Interactive collectible 150 includes printed circuit board 151, light emitting diode display including light emitting diodes 155, 156, and 157, electronic circuitry 153, and wireless recharging antenna 154. Printed circuit board 151 may be laminated inside of laminate housing and/or placed inside of a collectible housing to form collectible housing 158. For example, an electronics package may be sandwiched between multiple collectible layers (e.g., multiple layers of cardboard and/or polymer). An electronics package may be placed in an aperture on a collectible layer and that collectible layer may be sandwiched between one or more additional layers (e.g., layers of cardboard and/or polymer). Non-polymer layers may be any type of paper, wood, cardboard, metal, or any other type of non-polymer layer. Foam layers may also be utilized. Layers may be transparent, non-transparent, or selectively transparent. For example, a layer may a transparent layer with pre-printed information on a portion of the transparent layer so that portion is non-transparent and a different portion of that transparent layer may be transparent or semi-transparent so that light can travel through that portion to one or more light sensors and light can travel through that portion from one or more light emitting diodes. Apertures may be provided on layers such that there is no obstacle to light or other items to travel through the layers.

Interactive collectible 160 may be a printed collectible. Such printing may be completed before and/or after the physical structure of collectible 160 is formed. Housing 161 may include an internal electronics package having one or more internal displays each having light emitting diodes. The displays may be provided underneath the surface of the collectible and may be strong enough for light to communicate outside of the collectible (e.g., with or without printing about the display). One or more light sensors may be included in housing 161. Light sensor(s) may be provided underneath the surface of the collectible and may be sensitive enough for light to communicate into the collectible (e.g., with or without printing about the sensor(s)).

Printed indicia 165, 166, 167, and 168 may be provided on a collectible (e.g., on one or more surfaces of a collectible such as on the obverse and/or reverse surface of a trading card such as a sports card). For example, printed indicia 168 may be, for example, an image of a subject of a trading card such as an image of a particular athlete associated with that particular athlete's sports trading card or a particular entertainment figure associated with a particular entertainment trading card or a particular game character associated with a particular gaming trading card. India 167 may be a printed textual indicia of the name of a character and/or subject of the collectible. Printed indicia 169 may be, for example, additional information about a subject of a collectible such as a position of an athlete for a sports card providing that particular athlete. Printed indicia 168 may be, for example, additional information about a subject of a collectible such as the team of an athlete for a sports card providing that particular athlete. Information printed on a collectible may also be displayed on the collectible via a display. For example, the name of a subject may be printed in text in a display when a display is activated (e.g., by a light sensor). Additionally, audio stored on a collectible may associated with printed indicia. For example, the name of a subject may be spoken in audio when a sound generating system is activated (e.g., by a light sensor).

Process 170 may include the fabrication of an electronic puck. An electronic puck may be an electronics package including electronic circuitry and one or more power sources encapsulated in a laminated polymer. Persons skilled in the art will appreciate that an electronics package does not need to be laminated and can be provided in a collectible without encapsulation in a laminated structure. Trading card sheets may be printed in step 172. Trading card sheets may be cut into trading card layers that are utilized in fabricating a trading card. Accordingly, for example, a trading card sheet may be cut into multiple or several pieces for multiple or several trading cards, respectfully. An interactive trading card may then be formed with an electronics puck inside in step 173. Persons skilled in the art will appreciate that interactive trading cards may be formed in sheets and then cut into interactive trading cards. For example, a sheet with multiple or several apertures may receive multiple or several electronic pucks. One or more sheets may be affixed to the obverse and/or the reverse side of the layer including the pucks. The interactive trading cards may then be cut out of the sheet. Multiple types of trading cards can be fabricated from a sheet. Both static trading cards without electronics and interactive trading cards with electronics may be fabricated from the same sheet or sheets.

Trading cards may be put into packs in step 174. Trading cards may be collated into packs using a pre-determined collation rule set. For example, each pack may include 3 trading cards. Each pack may have 2 static non-powered trading card and 1 interactive trading card. A certain number of packs, such as 12, may be included in a box of cards. Each box of cards may include 1 interactive trading card of a particular rarity and 11 interactive trading cards of a different rarity. A number of boxes may be in a case. Each case may include 1 interactive trading card having a particular rarity different than the rarity of the other interactive trading cards. Packs may have the same number of cards in a box and/or case structure or may have different number of cards. Accordingly, a pack with an interactive trading card may have less non-powered static trading cards than a pack with an interactive trading card. Decoy cards may be utilized that have different thicknesses and different weights so that packs cannot be searched. Packs may be made from non-transparent (e.g., non-transparent and reflective) surfaces so that light cannot travel into a pack and turn an interactive card ON while the card is in a pack and, if the card is turned ON, so that light cannot travel outside of the pack. Step 175 may be provided where trading cards are put into boxes and/or cases. Persons skilled in the art will appreciate that any number of case structure may be used such as a certain number of packs may be put into a certain number of boxes, which may be put into a certain number of first tier cases, which may be put into a certain number of second tier cases, which may be put into a certain number of third tier cases and so on. Accordingly, for example, a user may open 1 third tier case and be provided with 2 second tier cases which may each have 2 third tier cases which each may have 8 boxes which each may have 4 packs. Step 176 may be provided in which a pack with an interactive trading card is opened. Person skilled in the art will appreciate that not all packs may include an interactive trading card. An interactive trading card may be provided one per box, one per first tier case, one per second tier case, one per third tier case, or one in a particular number of packs that is not correlated to a particular box or case structure. Step 177 may be provided in which an interactive trading card may be autonomously activated as it is removed from a pack of trading cards and provides an experience (e.g., a light show on a LED display). Step 178 may occur and a trading card experience may complete and the interactive trading card may enter a sleep mode to conserve energy. Step 169 may be provided in which a user re-activates a trading card (e.g., via pushing a mechanical button or, as per another example, removing light from a light sensor for a particular period of time and then letting light be received from the light sensor for a period of time). At a re-activation an experience (e.g., display animation) may be provided in step 180. Persons skilled in the art will appreciate that a card may have one, two, or more than two animations (e.g., more than 10 animations) and such animations may be provided in order, may be provided randomly, or may be provided under certain conditions (e.g., certain intensities of light or during certain times of the day or during certain other conditions (e.g., if a particular light sensor was activated versus another light sensor or during certain dates).

Process 190 may be included and may include step 191 where an interactive collectible such as an interactive trading card is asleep. The collectible may wake up out of a sleep mode periodically to check one or more light sensors (or other types of sensors) in step 192. If a light sensor, or other sensor(s), are determined to be activated (e.g., by a processor) then an experience may be provided to a user in step 193. The collectible may return to sleep mode and periodically wake up to check one or more sensor(s) in step 194. A collectible may be recharged in step 195 (e.g., wirelessly recharged). A collectible may be packaged in a pack and/or a box and/or a case as an encapsulated collectible in an encapsulated case with an encapsulation tag. A trading card may have an RFID chip associated with the trading card while an encapsulation case may have an RFID chip associated with the encapsulated collectible. Collectibles may be sold directly outside of packs (e.g., blind packs of unknown random cards or unblind packs of set and known cards such as a card set pack).

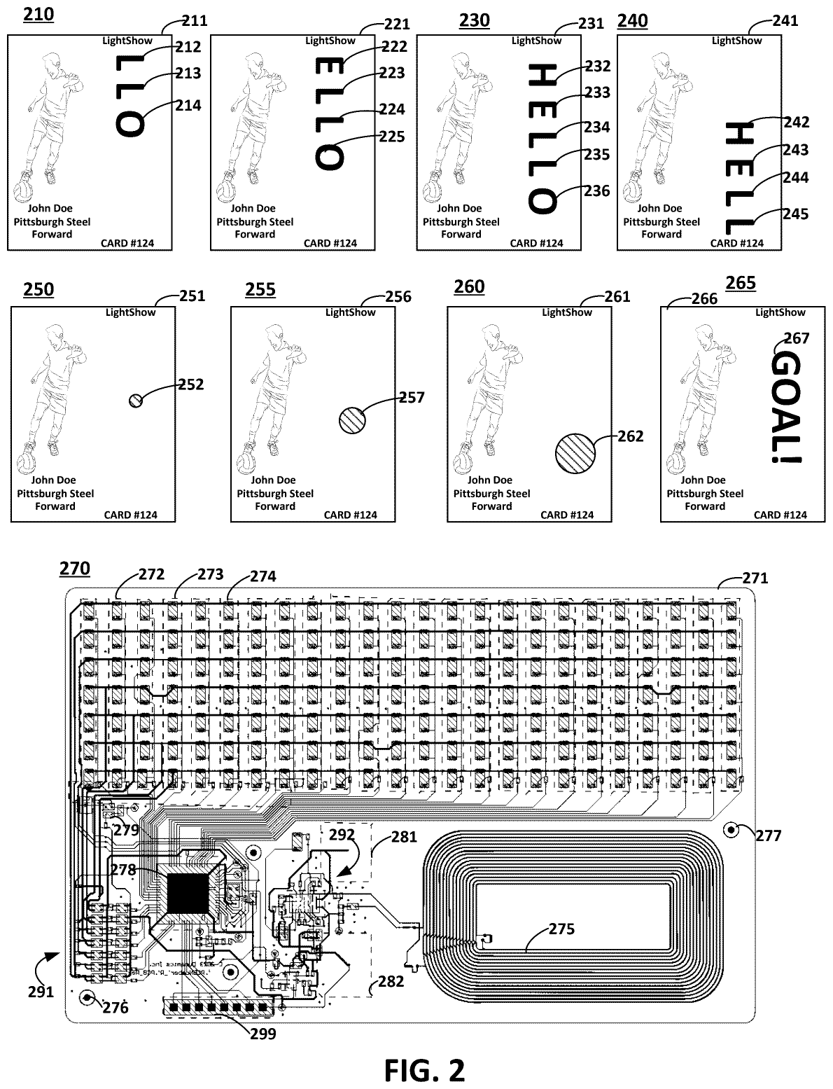

FIG. 2 shows interactive collectible 210 that may be, for example, a trading card such as a sports trading card. Trading card 211 may include housing 211 that may include a display, such as an LED display, such that the light emitted from the LED travels through a surface of housing 211 so that a consumer does not see the display, just light generated from the display. Accordingly, for example, an electronic trading card may be fabricated from the same surface materials as a non-electronic trading card so that the card may be visually indistinguishable when the card is OFF (e.g., in sleep mode not providing any human perceivable experiences such as light animations). A display may have a particular number of LEDs such that numeric, alphabetized, or alphanumeric characters may be shown on the display. Accordingly, for example, letters 212, 213, and 214 may be displayed on a display (e.g., three letters. The characters may be displayed in a stationary position or may be moved across the display so that more characters can be shown than can be displayed on the display. The surface of a collectible may be non-transparent to human perception (e.g., cardboard) or transparent (e.g., a clear transparent polymer). The surface of a collectible may be cut-out around a particular LED or set of LEDs or a particular portion of a display or all of an area display or greater than the area of a display. Accordingly, a user may see at least the area having the display without interference (e.g., if not a larger area).

Collectible 220 may be provided and may be a collectible similar to, for example, collectible 210. Four characters may be provided such as characters 222, 223, 224, 225. Collectible 220 may be, for example, a temporal instance after the instance of collectible 210. A word (e.g., “HELLO”) may be scrolled across the display in a particular font from a set of fonts and at a particular size out of a set of sizes and out of a particular language out of a set of languages.

Collectible 230 may be provided and may display 5 letters such al letters 232, 233, 234, 235, and 236. Collectible 230 may provide character and/or other indicia movement and may be providing a display instance later than the display instance of collectible 220. For example, collectible 230 may display “HELLO” and “HELLO” may move horizontally and/or vertically across an axis of the card (e.g., if a trading card is in a portrait configuration, the text may scroll vertically and/or horizontally with respect to the portrait configuration).

Collectible 240 may be provided and may include a display in housing 241 and the display may provide characters 242, 243, 244, and 245. Characters may be scrolled so they start appearing on one side of a display and then fall off the other side of the display. For example, collectible 240 may display four characters. Collectible 230 may show a display instance temporally before the display instance of collectible 240 and the last character in a word may fall off the display in the display instance of collectible 241 (e.g., so the text appears to move off the display). Accordingly, words and sentences can be moved onto and off the display so that the display can provide information to a user. Alternatively, for example, text may be cut up and displaced on a display serially so that the display strings together multiple segments of text. Persons skilled in the art will appreciate that a display may be able to display indicia and receive user inputs. For example, a touch display (e.g., a capacitive touch display) may be provided where a user can touch the display and interact with the collectible. For example, a user may be provided with two separate indicia (e.g., the word “YES” and the word “NO”) and the consumer can select one or multiple or several selections. For example, a keypad may be provided such that the user can enter in a single digit or multiple or several digit answer and press another indicium (e.g., “enter” to enter the information into the collectible. A keypad, such as an alphanumerical keypad) may be displayed and interacted with. Manual inputs may, alternatively, be located elsewhere on a collectible such as about one of the perimeters of a display. Indicia may be printed on the collectible itself and aligned with the manual input sensors (e.g., capacitive sensors) so that the user can understand where to press. The display may also provide indicia associated with a manual input within the proximity of the manual input that is located off the display. Accordingly, for example, the display may say “A” “B” or “C” above three user interface areas (e. g., an area printed with “1” in a circle, an area printed with “2” in a circle, and an area printed with “3” in a circle. Volume and/or light intensity and/or contrast may be modified via one or more controls that a user can interface with (e.g., one or more capacitive sensors) located underneath the surface of a collectible such as a trading card, comic book, event ticket (e.g., sporting event or music event or movie event admission ticket), figurine, or any type of collectible. A microphone may be provided to receive verbal commands as well as, for example, record voice so the voice can be played back. In doing so, for example, a user or an athlete may program a card with a particular segment of speech (e.g., an athlete may program a particular card with one message and another particular collectible with another message). Light sensors may also receive visible data (e.g., from a TV or another display such as a display from a portable telephonic device or from another collectible0. Light sensors may also receive non-visible light (e.g., infrared light).

Collectable 250 may be provided and may include a display in housing 251 and may show indicia and animate that indicia. For example, collectibles 250, 255, 260, and 265 may be the same collectible with the same electronics in housings 251, 256, 261, and 266, respectively, and may animate one or more indicia on the display over time. For example, a ball may be displayed to appear to be kicked to the user and may enlarge across indicia 252, 257, and 262 before the English language punctuated statement “GOAL!” is displayed as indicia 267.

Architecture 271 may be included and may be a printed circuit board that includes connections for various electrical components. Printed circuit board 270 may be a multiple layer, single layer, or several layer circuit board. Materials may be sandwiched between circuit board layers. A circuit board may have electrical components on both first side and a second side of a printed circuit board. The printed circuit board may be laminated in a flat position or a curled position. The circuit board may be flexed and bent into a curved shape such as a cylinder and mechanically affixed to a housing structure (e.g., screwed into the foot or arm of an action figure) or may be laminated in a flexed position such as rolled into a cylinder and then laminated into a cylinder structure. A circuit board may be flexible or non-flexible. A circuit board may be less than three thousandths of an inch thick, less than four thousandths of an inch thick, less than five thousandths of an inch thick. A circuit board may be fabricated from FR4 (e.g., non-flexible or flexible FR4), polyamide, or any circuit board material.

Architecture 270 may include one or more antennas 275 that is laid out into a circuit board via a conductive material (e.g., a copper). Persons skilled in the art will appreciate that a material such as a ferrite may be provided on a surface of the antenna to increase the performance of the antenna in particular situations. Antenna 275 may be, for example, a wireless recharging antenna. Multiple antennas may be provided on a circuit board with different numbers of windings and different shapes and sizes for different types of communications. For example, a communications antenna may be provided around the border of a printed circuit board (not shown) for communicating wirelessly to devices so as to decrease interference to and receive decreased interfere from other components of the circuit board. Circuit board 271 may include connections for any number of LEDS such as LED connections 272, 273, and 274. LED rows may be provided for a display (e.g., six, seven, eight, or less than six or more than six LEDs) in a row. Any number of rows may be provided such as, for example, less than ten, ten, or more than ten rows (e.g., 24 rows). Accordingly, for example, twenty-four rows of seven LEDS provides a display with one hundred and sixty-eight LEDs. More than, or less than, 168 LEDS may be provided in one or more than one display for a collectible. Persons skilled in the art will appreciate that the LEDS may all have the same color for a collectible (e.g., white, blue, orange, red, yellow, pink) or may have different color combinations (e.g., some rows may be red while other rows are blue while other rows are white). A row of LEDs may have different colors across the row (e. g., two, three, or more than three colors). LEDs may not be populated on particular collectibles, for example, in order to reduce costs. For example, suppose an aperture only covers a portion of a display, the LEDS that are not aligned with the aperture may, for example, not be populated on those collectible displays. Accordingly, for example, multiple types of collectibles (e.g., multiple different types of trading cards) may be manufactured from the same electronics package. Control circuitry 291 may be provided to provide controls to portions of electronics such as, for example, provide multiplexing across displays rows and/or columns. One or more processors may be provided about location 279 to provide processing for electronic circuitry. Mechanical alignment apertures 276 and 277 may be provided, for example, so that tooling may be mechanically coupled to the circuit board or product components may be mechanically coupled (e.g., fixed such as screwed into via a screw) to a circuit board. Multiple or several circuit boards may be utilized and mechanically and/or electrically coupled together. For example, multiple circuit boards may be fabricated and the circuit boards may be mechanically coupled together and may communicate to each other via wired electrical connections or via wireless connections. Control circuitry 292 may be provided and may provide controls for circuitry such as, for example, wireless recharging controls for one or more wireless recharging antennas. A battery (e.g., a flexible battery) may be mechanically and electrically coupled to circuit board 271 via connections 281 and 282. A battery may be placed over antenna 275 and a piece of ferrite may be provided between the battery and antenna 275.

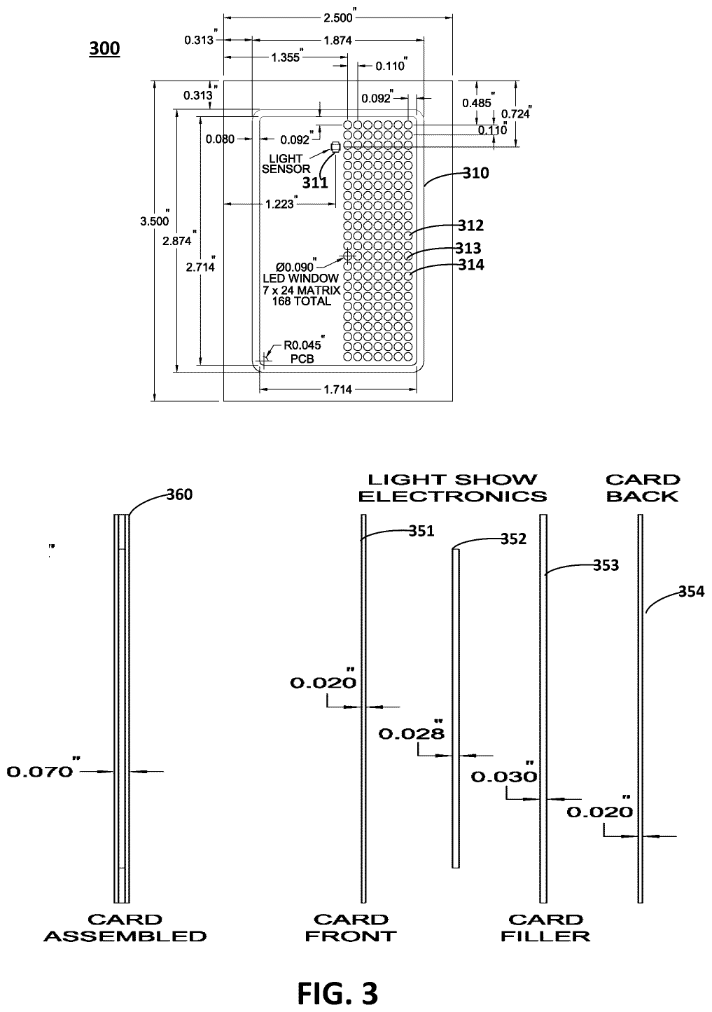

FIG. 3 shows architecture 300 that may include, for example, circuit board 310 with LEDs 312, 313, and 314. Windows may be provided about an LED (e.g., via not printing above an LED) to provide light but to also provide printing about the LEDs. Architecture 300 may be provided that provides collectible 360 via the formation of layers 351, 353, and 354 and electronics package 352 (e.g., a laminated electronics package or non-laminated electronics package). Layers 351, 353, and 354 may be, for example, any material such as a cardboard and/or a polymer.

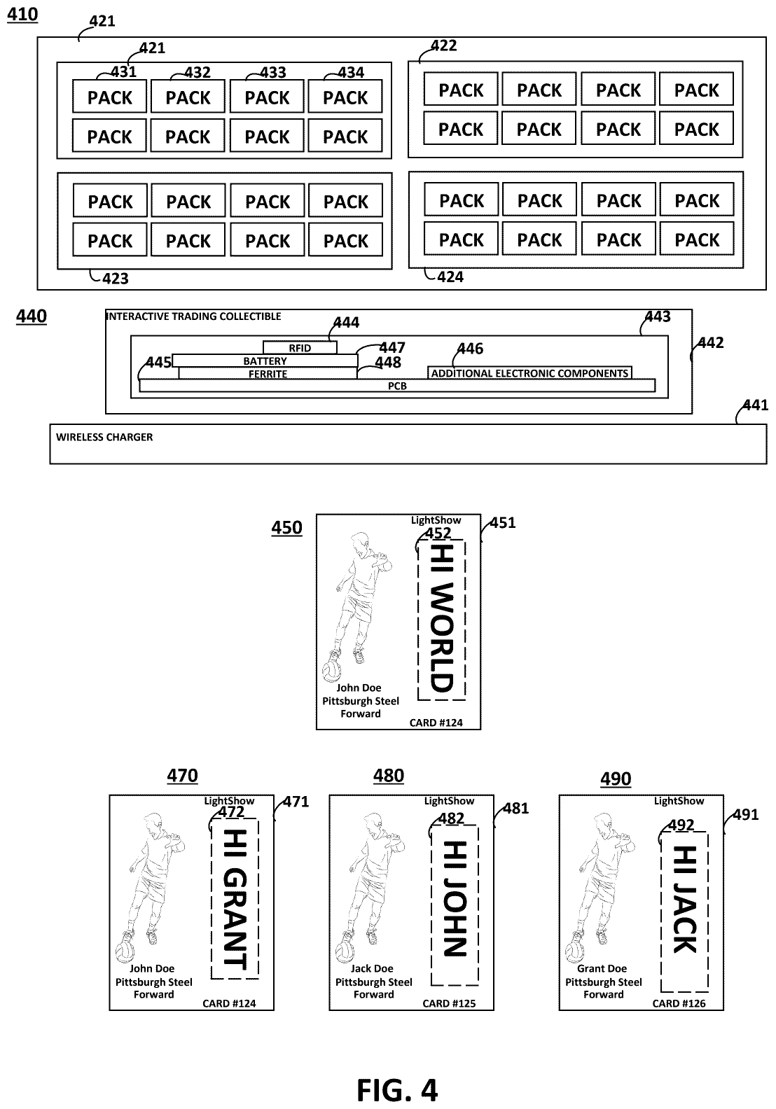

FIG. 4 shows collectible architecture 410 that may include collectible trading card case 410 including collectible trading card boxes 421, 422, 423, and 424. Each box may include collectible trading card packs (e.g., collectible packs 431, 432, 433, and 434) which may, in turn, include one or more collectible trading cards. Collation rules may be utilized so a particular number of packs have at least one electronic trading card and a particular number of other packs having no electronic trading cards. Collation rules may include pack level collation rules, box level collation rules, and/or case level collation rules.

Collectible architecture 440 may be provided and may include interactive electronic trading card 442 operable to be recharged by wireless charger 441. Collectible 442 may include laminated housing 443 that may include printed circuit board 445 with electronics 446, ferrite 448, battery 447, and RFID 444. RFID 444 may be, for example, a separate sticker that is adhered to battery 447 and may be individually programmed and accessed. RFID 444 may have its own circuitry and may include its own chip so that RFID may be individually programmed and accessed separate from, for example, a processor in electronics portion 446. Persons skilled in the art will appreciate that RFID 444 may be included in additional electronics 446 and may have an antenna on the printed circuit board (e.g., fabricated during the fabrication of the printed circuit board) and may be electrically coupled to a RFID control circuit and/or a processor. In doing so, for example, the processor may be provided that may modify data able to be communicated to and from the RFID antenna. Electronics 446 may be powered by battery 447 via connections in PCB 445.

Collectible 450 is provided that may include display 452 inside housing 451. Persons skilled in the art will appreciate that collectibles may communicate with each other. Collectibles may identify each other and provide different experiences based on how many collectibles, the type of collectibles, and the particular instances of collectibles. For example, collectibles 470, 480, and 490 may be of different subjects (e.g., John, Jack, and Grant). Collectible 470, 480, and 490 may have similar or different displays 472, 482, 492, respectively, in housings 471, 481, and 491, respectively. For example, display 472 may be of one color (e.g., RED), while display 482 may be of a different color (e.g., blue), while display 492 may be of multiple colors (e.g., multiple color LEDS or different LEDS each having different, single colors). The collectibles may communicate with each other, identify each other, and provide indicia based on the combination of collectibles communicated with. For example, each collectible may display the name of the collectibles it connects with. So, for example, collectible 470 may display an identifier/name of collectible 480 followed by an identifier/name of collectible 490 if collectible 470 comes into communication with both collectible 480 and 490. The collectibles may perform animations as a group. For example, the collectibles may each provide separate display animations as part of a large display animations (e.g., a firework may fly from one collectible display to another collectible display before exploding in a third collectible display of a third collectible). Accordingly, for example, collectibles may have a discussion together (e.g., Michael Jordan may talk to Scottie Pippen and Dennis Rodman and vise versa). Collectible trading cards of members of a music band may each play their portion of a song.

A digital storage structure, such as a digital non-fungible token, may be created for each collectible at the same time the collectible is manufactured. Digital storage structures may be created, respectively, after a collectible is manufactured. Accordingly, for example, a NFT, or other digital storage structure, may be created for each collectible and information may be updated on a collectible when certain events occur (e.g., the collectible interacts with another collectible) and this information may be provided (e.g., via a connection with a computing device) to a digital storage structure such as a private ledger, public ledger, private blockchain, public blockchain, or any type of digital storage structure. For example, a new NFT or other digital token/structure may be created with each collectible and information associated with the NET may be stored in a physical memory of the collectible such that the physical collectible can verify its associated digital token/structure and the digital token/structure can be utilized to verify its associated physical collectible. Multiple collectibles may be associated with one or more tokens (e.g., a collectible and a certificate of authenticity for that collectible or a multiple card sketch collectible). Such an NFT could be, for example, a blockchain (e.g., private and/or public blockchain) and/or a non-blockchain NFT and/or tokenized data. For example, an NFT may be a multi-ledger blockchain that can be utilized on a public blockchain (or more than one public blockchains) as well as one or more private blockchains. Such a multi-ledger NFT may have different memory sectors assigned to different ledgers. For a public blockchain, for example, the platform may be the transacting entity so that users of the platform do not need to be individual issued public blockchain wallets. An NFT may include, for example, the same information and additional information to the informational tag or different information. For example, a stored data structure for a collectible item may include the name and/or handle of the manufacturer, the date of manufacture, the original buyer, additional buyers, the name of the collectible and other collectible information. Accordingly, for example, a digital data structure, such as an NFT may be created for each collectible that stores identifying information for the individual that submitted the item as well as a chain of custody for owners of the item throughout the life of the item on the platform or after existing the platform. Persons skilled in the art will appreciate that other types of identifiers such as NFTs may be utilized by third parties. Identifiers of such third party NFTs may be stored in a data structure and such NFTs may be imported into the receiving platforms processing (e.g., blockchain) or the management of the NFT may be transferred to the receiving platforms management system such as a blockchain management system.

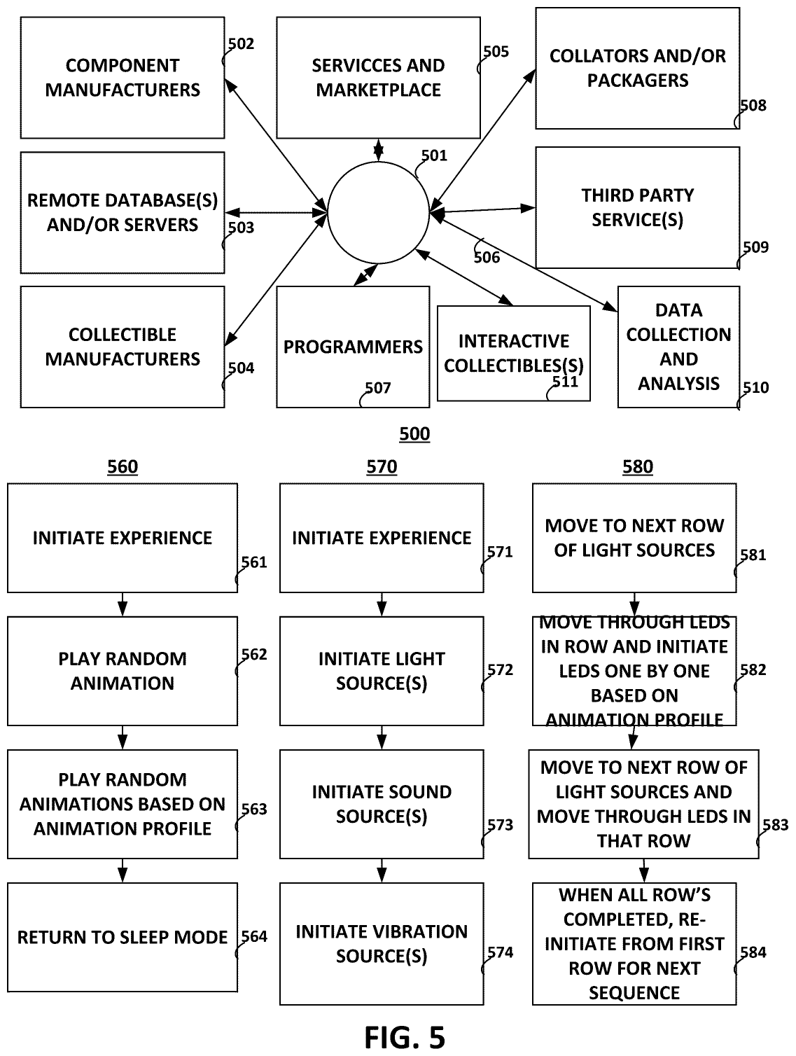

FIG. 5 shows topology 500 that may include, for example, communications medium(s) 501 that may be, for example, any combination of wired, wireless, internet, intranet communications mediums. Any entity or process or other structure of topology 500 may communicate unidirectionally and/or bidirectionally with any other entity, process, and/or structure of topology 500 through communications medium(s) 501.

One or more public and/or private blockchains (e.g., or other ledger such as a database that represents unique items with unique identifiers) may be provided in ledger(s) 503. One or more services and/or marketplace(s) may be provided in marketplace(s) 505 which may be, for example, trading platforms, buy/sell platforms, private offer platforms, auction platforms, finite ending time auction platforms, auction platforms with multiple bidding phases such as pre-bidding, primary bidding, and/or extended bidding sessions, and any other type of ownership transaction platform where items, for example may be transacted between owners for monetary amounts and/or different collectible items. Marketplaces 505 may, for example, enable fractional ownership and include fractional royalties associated with all future ownership transitions or a portion of future ownership transitions (e.g., buy/sell transactions but not trading transactions). Services and marketplace(s) 505 may also include receiving items, recording and verifying data associated with the stored items, creating and managing data storage structures such as NFTs for each item, image capturing, storage, shipping, and any other actions and services.

One or more auction house(s) 509, such as third-party auction houses, may be utilized for example by services and marketplace 505). A receiving, storage, and marketplace platform may, for example, have options for collectible owners to auction their items at different auction houses and/or request that an auction house review the item and verify the auction house would auction the item and under what terms (e.g., an offered buyer's premium, offered share of a seller's premium, type of auction such as an live weekly auction or a live monthly or quarterly auction). The collectible owner can then accept an offer for an auction or may provide a counteroffer. The receiving, storage, and marketplace listing entity may, for example, obtain a referral fee (e.g., a revenue share) of items sourced by third party entities for sourced collectible items. Additionally, for example, third parties, such as third-party auction houses, may source items for a receiving, encapsulation, image capture, and/or storage service and may obtain a referral fee, value share, and recurring value share (e.g., a percentage of marketplace sales for a period of time such as more than 1 year, 10 years or less, or any period of time) for sourced items. For third party services that ship collectibles, for example, a shipping option may be to send the item(s) to a receiving, image capture, and/or storage entity and may also include a sign-on to that entity. An entity's sign-on may be utilized on a website for any other entity, for example, in order to, for example, assist with increased customer identification, security, anonymity, and/or services.

Third party services 509 may be any third-party services such as third-party services that may digitally or physically provide value-added benefits to a collectible (or other item). For example, third-party services) 509 may include shipping services, courier services, armed courier services, autograph authenticators, independent consultants for data entry, data verification, item authentication, item grading, and/or any other, for example, value added service to a collector, collectible item, or any other entity and/or object. Persons skilled in the art will appreciate that any actions of topology 500 may be performed at any one entity or provided across any number of entities (e.g., a subset of entities or all entities) of a topology.

One or more grading companies, such as grading companies 509, may be provided. Grading companies may, for example, white label a platform (e.g., a receiving, scanning, storage, platform) so that the grading company can provide the platforms services on its websites. A storage facility may white label storage so that items can move between platforms of different entities (e.g., be imported and/or exported) without moving the physical item.

One or more appraisal services 509 may be added and may be utilized to, for example, appraise an item as well as project an appraisal if the item, for example, met certain criteria such as met certain grading criteria. In doing so, for example, a collectible may be appraised and a value for various condition grades may be provided such that a collector may better determine if grading would be economically beneficial as well as what grading company would be economically beneficial. Accordingly, an appraisal service may also appraise items in different grades from different grading entities even if, for example, the item is not yet graded with a particular grading company and/or has not yet been graded at all.

One or more insurance services, such as insurance services 509, may be provided. Insurance services may, for example, provide an entity, such as entity 505, with a particular amount of coverage and the insured entity may then partition the insurance coverage to different platform users based on, for example, the platform user's membership tier, estimated value of the user's collection, and/or number of collectibles in the user's collection. Supplemental insurance may be sold to a platform user, for example, for an additional fee. One or more remote database(s) and/or services may be added to a topology and may assist, for example, with information brokering between entities as well as, for example, be informational centers in which information may be received to enhance the capabilities of an entity. Information may be retrieved, stored, updated, altered, deleted, or any other action such as the implementation of access permissions based on entity, entity status, or any other attribute or set of attributes.

Interactive collectible 511 may be provided and may be able to communicate with any of the structures of topology 500. Accordingly, interactive collectibles may, for example, be able to be programmed via a wireless or wired connection from structures of topology 500. For example, a grading company may program a grade into memory of an interactive collectible such that the interactive collectible may be able to display a grade to verify a grading encapsulation case has not been tampered with. Entities may be provided with security keys to access memory or a particular partition of memory for a collectible. An entity of topology 500 may communicate with the manufacturer of collectible 504 to obtain a key for that particular collectible for that particular data storage event or the entity may provide information to the collectible manufacturer for storage in collectible 511 (e.g., via a wireless communication or a wire-based communication) to collectible 511.

Process 560 may be included and may include step 561 where a collectible may initiate an experience, a random animation may be provided in step 562, a random animation may be played based on an animation profile (e.g., rules for playing experiences such as animations) in step 563, and return to sleep mode in step 564.

Process 570 may be included in which an experience is initiated in 571, light source(s) are initiated in step 572, sound source(s) are initiated in step 573, and a vibrational source(s) are initiated in step 574.

Process 580 may be included in which a processor of a collectible may move to the next row of light sources in step 581, move through LEDS in a row and initiate LEDS one on one based on an animation profile in step 582, and move to the next row of light sources and move through LEDs in that row in step 583, and when all rows completed re-initiate from first row for next display sequence in step 584.

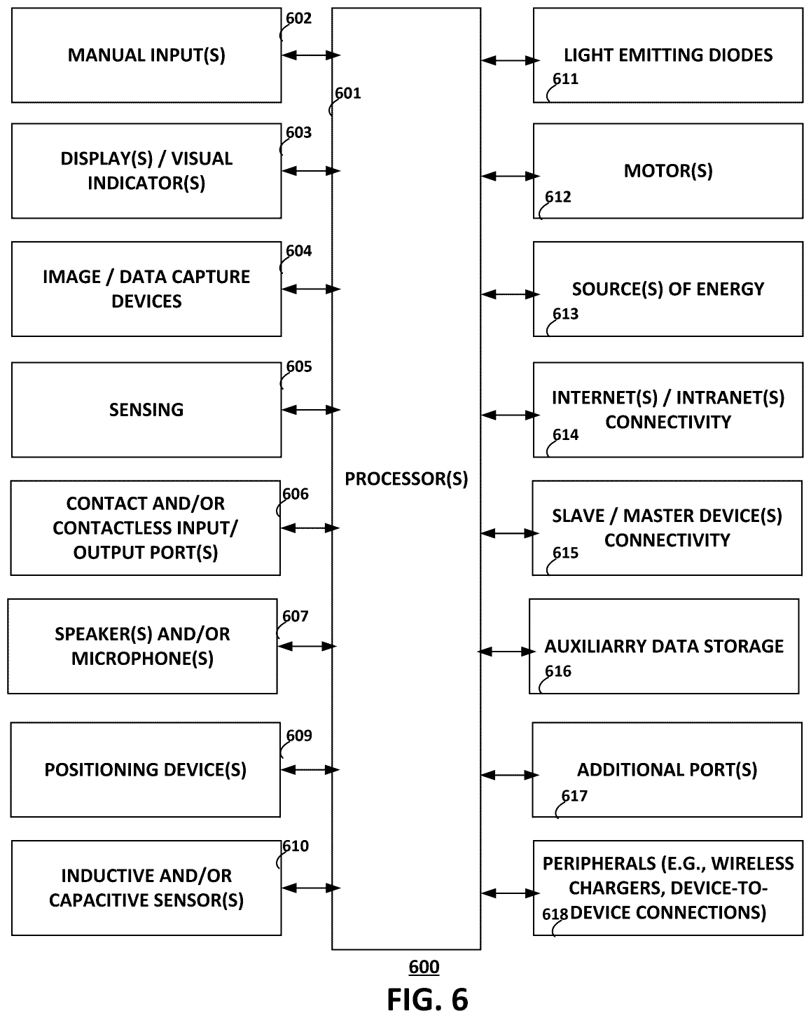

FIG. 6 shows architecture 600 that may be utilized as an architecture for any electronic and/or electromechanical system such as one or more interactive electronic collectibles.

One or more processors 601 may be included in architecture 600. Such processors 601 may, for example, include secure data storage (e.g., secure flash and/or secure ROM). Manual inputs 602 may be included which may be, for example, manual and/or virtual buttons such as a virtual button on a graphical user interface. Any number of displays and/or visual indicators (e.g., light sources such as LEDs) may be included as indicator(s) 603. Image and/or data capture device(s) 604 may be included. Additional sensing device(s) 605 may be included. Contact and/or contactless input and/or output port(s) may be included as port 606. Accordingly, remote devices may communicate with architecture 600 through wired and/or wireless communications through, for example, contact and/or contactless port(s) 606. Any number of speaker(s) and/or microphone(s) 607 may be included. Positioning device(s) 609 and/or locating devices (e.g., GPS, local positioning, telemetric locating, or nay type of locating/positioning) may be included in positioning device(s) 609. Accordingly, for example, a device may determine where in a facility or in the world the device is located. Inductive and/or capacitive sensors 610 may be included in any collectible. Any number of image and/or data capture devices may be included. Any number of displays and/or other light indicators may be provided in component 611 (e.g., light emitting diode display). Motors 612 may be provided (e.g., to mechanically move a component in a window of a trading card). For example, a trading card may have a viewing window into a cavity and a character (e.g., Michael Jordan) may be moved upon activation to simulate dribbling across the card and dunking into a basket. One or more sources of energy 613 may be included which may be, for example, one or more batteries such as rechargeable batteries as well as one or more external sources of energy that are utilized to provide power via a wireless and/or wired power transmission process/system. One or more internet(s) and or intranet(s) may be utilized by architecture via connectivity 614. Auxiliary data storage device(s) 616 may be provided. Remote processing may also be provided and utilized by architecture 600. One or more additional ports 617 may be included. Any additional peripheral device9s) 618 may be included such as, for example, any additional peripherals 618 such as, for example, wireless chargers and/or device to device communications). Persons skilled in the art will appreciate that multiple collectibles may work in tandem to provide a solution and/or experience.

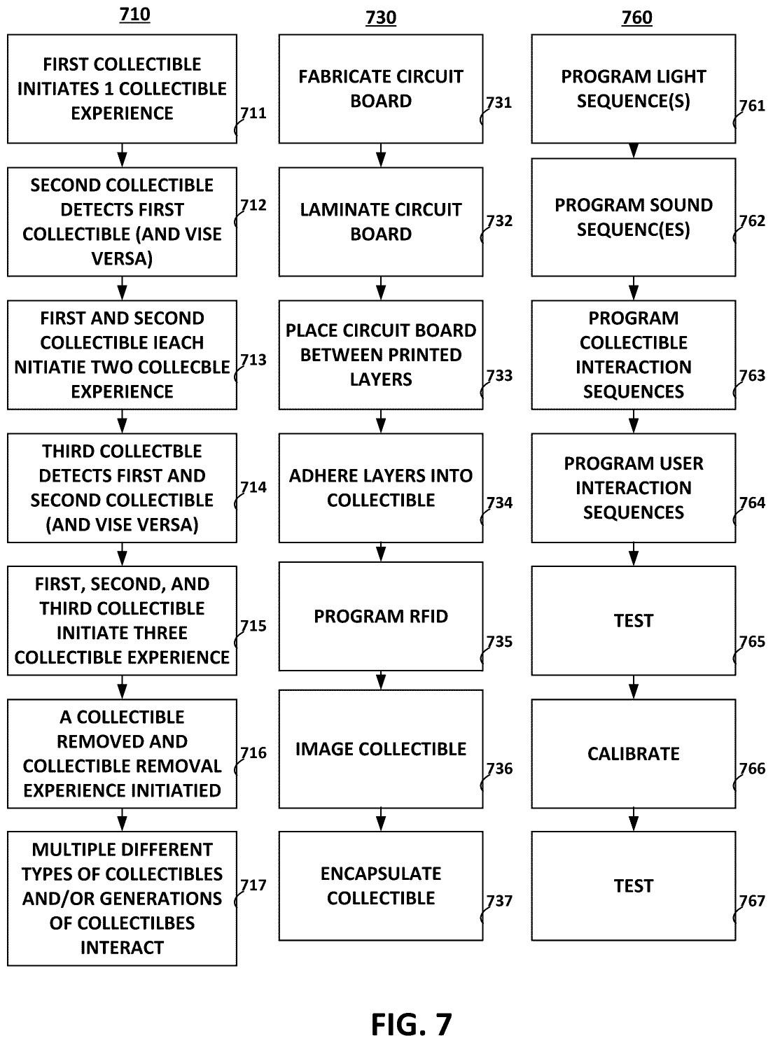

FIG. 7 shows flow chart 710. Step 711 may be included with which a first collectible initiates its first collectible experience. Step 712 may be initiated in which a second collectible detects the first collectible (and vise versa). Step 713 may be provided in which the first and second collectible each initiate two (e.g., separate) collectible experiences. Step 714 may be provided in which a third collectible detects first and second collectibles (and vise versa). Step 715 may initiate in which the first, second, and third collectibles initiate their own experience (e.g., three different experiences are initiated). Step 716 may be provided in which a collectible is removed from the proximity from the other collectibles and the collectible removal experience is initiated (e.g., a word “bye” may appear on a display). Multiple different types of collectibles and/or generations of collectibles may communicatively and experientially interact in step 717.

Flow chart 730 is provided. Step 731 may be included in which a circuit board may be fabricated. Step 732 may be provided in which a circuit board may be assembled with electronics and then laminated into a laminated electronics package. Step 733 may be provided in which the electronics package is placed between pre-printed layers. The layers may be adhered in step 734 to form a collectible. An RFID may be programmed in step 735 (e.g., an RFID internal to the collectible). The collectible may be imaged in step 736 and encapsulated in a protective case with an identification tag in step 737 (which may have a separate RFID for the collectible case encapsulated collectible).

Flow chart 760 is provided. Step 761 may be included in which light sequence(s) may be programmed into a collectible. Sound sequence(s) may be programmed in step 792 into a collectible. Collectible interaction sequences may be programmed into a collectible in step 763. User interaction sequences may be programmed into a collectible in 764. A collectible may be tested in 765. The operation of a collectible may be modified and/or calibrated in step 766. For example, if a collectible display is providing light that is dimmer than a specification then the intensity of the light may be detected and increased in step 766. A collectible may be tested in step 767 for operation against operational standards one or multiple times (e.g., separated by a minimum period of time).

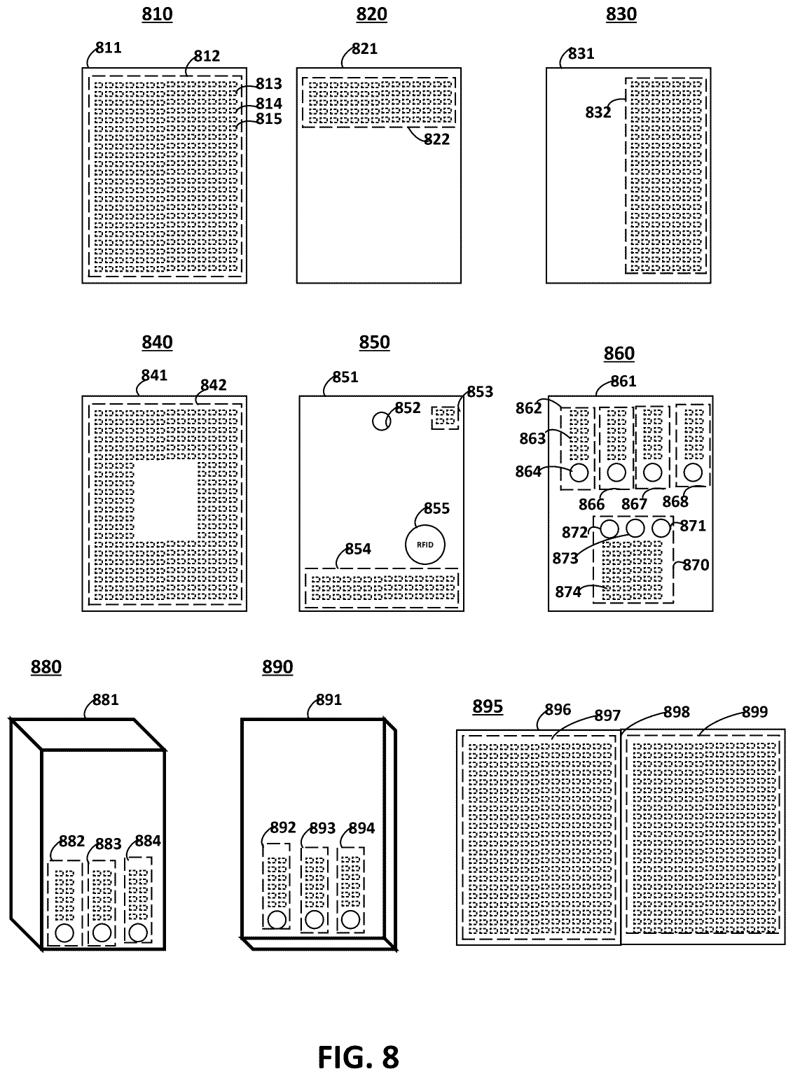

FIG. 8 includes collectible 810 which may include collectible housing 811 having display 812 that includes LEDS 813, 814, and 815. Display 812 may be located over at least 50 percent, at least 60 percent, at least 80 percent of the surface area of a surface of the collectible.

Collectible 820 may be included that may include collectible housing 821 and one or more displays 822. Display 822 may cover less than 50%, less than 30%, or less than 20% of a surface of a collectible.

Persons skilled in the art will appreciate that a collectible may have more than one surface and that displays (e.g., LED displays) may be provided on multiple, several, or all surfaces. A trading card may have a display of a first size on the front of a trading card and a display of a second size (e.g., a smaller display) on the back of a trading card).

Collectible 830 is provided and may include collectible housing 831 and display 832 provided in a vertical configuration when collectible 830 is provided in a portrait configuration. Display 832 may be less than 60 percent, less than 50 percent, less than 40 percent, less than 30 percent, less than 20 percent of the surface area of at least one of the surfaces of a collectible.

Collectible 840 is provided and may include display 842 in collectible housing 841. Display 842 may take any shape and may provide, for example, a border around a portion of a collectible (e.g., a border around an image of a subject. LEDs may not be populated during manufacturing to form different shape and size displays or different circuit boards with different LED display configurations may be utilized.

Collectible 850 may be provided and may include collectible housing 851 that includes light sensor 852, display 853, display 854, and RFID 855.

Collectible 860 may be provided and may include housing 861 and may include display and interactive element section 862 that may include display portion 863 and manual input portion 864 so a user may interact with portion 864 and receive an interaction from portion 863. Display and manual input portions may appear multiple and/or several times on one or more surfaces such as in portions 866, 867, and 868. Portion 870 may include display 874 and manual interfaces 871, 872, and 873. Manual interfaces may be mechanical buttons or non-mechanical buttons (e.g., light sensors and/or capacitive sensors).

Collectible 880 may be, for example, a box such as a figurine box and may include any number of displays and/or mechanical input sections 882, 883, and/or 884.

Collectible 890 may be, for example, a book such as a comic book, magazine, or other publication and may include any number of displays and/or mechanical input sections 892, 893, and/or 894.

Collectible 895 may be, for example, a booklet such as a trading card booklet and may include any number of foldable partitions such as two-fold lines, for three partitions. Collectible housing 896 may include fold line 898 and display 897 on a partition and display 899 on another partition. Light sensors may be located on one or multiple partitions on one or multiple surfaces of each partition.

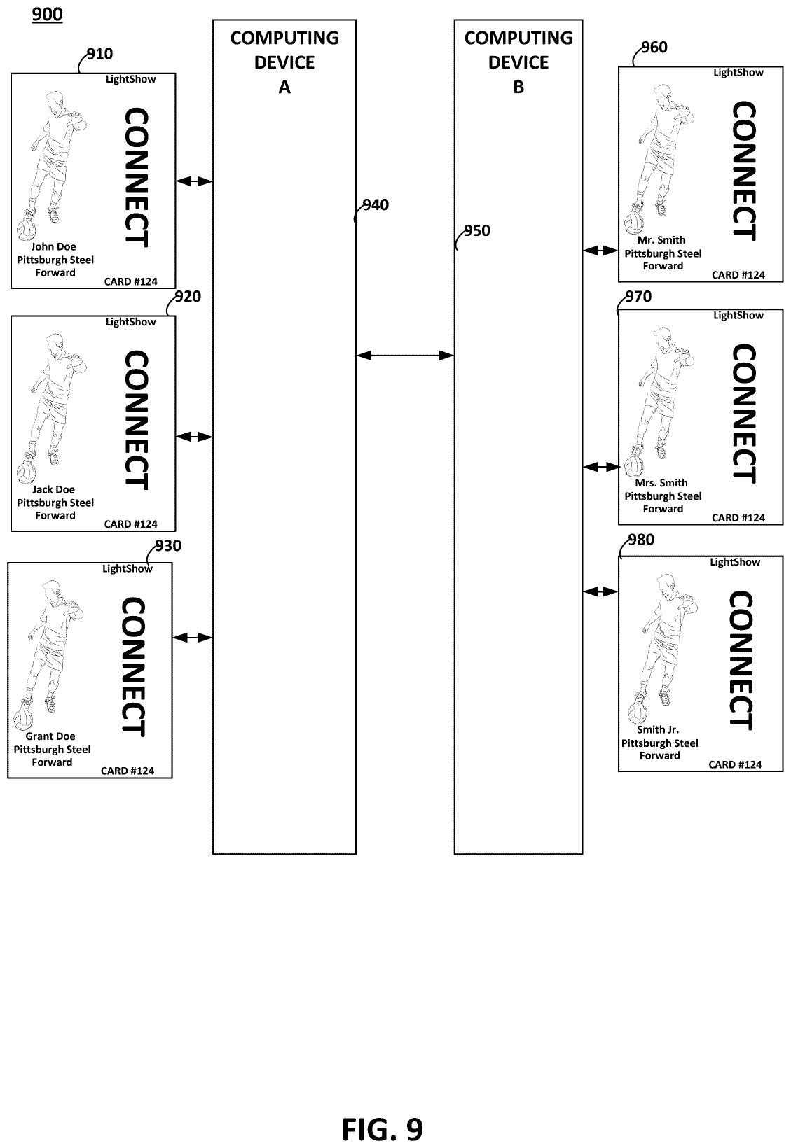

FIG. 9 shows architecture 900 that may include computing devices 940 and 950 that may communicate with each other (e.g., via a wired connection and/or a wireless connection). Computing device 940 may communicate with collectibles 910, 920, and 930. Computing device 950 may communicate with collectibles 960, 970, and 980. Computing device 950 and 960 may provide information about the collectibles to each other and may upload/download information to collectibles. In doing so, an experience may be able to be provided across remote collectibles and users may interact with a collectible and one location and have an impact occur to a collectible at another location as the collectibles may be communicatively coupled through the communicative coupling of device 940 and 950. Accordingly, for example, a game may be placed between two remote users that each use their own physical collectibles at their own remote locations and the collectibles may interact as if they were together in the same location (e.g., information may be transferred and modified on collectibles). Accordingly, for example a deck of interactive electronic trading game cads may play a game remotely with another deck of interactive electronic game cards via devices 940 and 950.

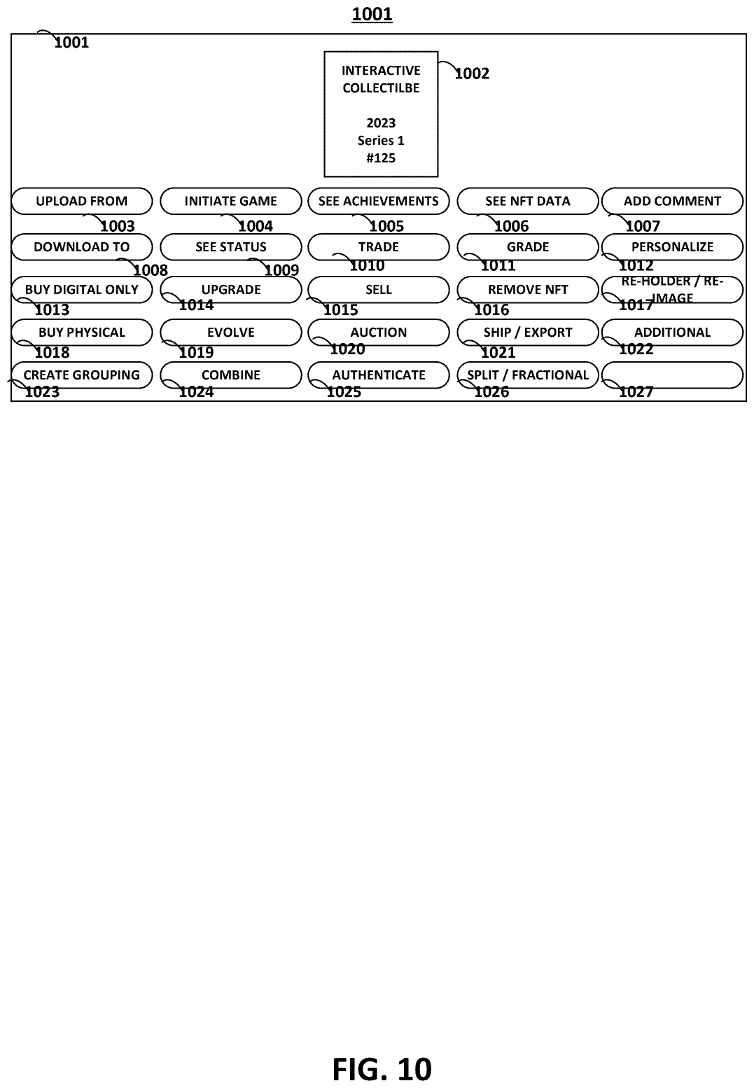

FIG. 10 shows a graphical user interface 1001 that may be, for example, a native application or browser on a device such as a mobile phone and/or stationary computer. A digital address entry window may be provided which may be, for example, a website address entry window and/or a search window for a search engine and/or a search window for a receiving and storage platform. Navigational controls may be utilized, for example, to move between location addresses. Virtual buttons 1003 to 1027 may be provided and may take a user to associated information such as, for example, a new graphical user interface (e.g., a new webpage and/or new native application page) or a different location on a graphical user interface (e.g., webpage and/or native application page).

Graphical user interface 1001 which may be a details page associated with a particular copy of a particular interactive electronic collectible

Option 1003 may be provided and may provide a user, for example, with the ability to upload data from an interactive collectible.

Option 1004 may be included to initiate a game on one or more electronic collectibles.

Option 1005 may be included to determine if any achievements are associated with a collectible. An electronic collectible may reward the user by having the user complete a particular number of tasks (e.g., collect an entire insert set and a new animation may be played on a collectible and/or able to be downloaded to one or more of the collectibles.

Option 1006 may be provided for a user to see digital data, such as NFT data, for a collectible.

A comment may be added for a page associated with a collectible or added in memory of a collectible in step 1007. Comments may also be viewed using option 1007.

Option 1008 may be provided for example, to download data to an interactive electronic collectible. NFT data, or other stored data associated with a collectible, may be viewed with option 1006.

Status of a collectible may be viewed in step 1009 which may include, for example, manufacturing and operational data such if whether or not any software updates are available for a particular collectible.

A collectible may be identified and GUI 1001 may be initiated by a user entering a collectible ID into a page and/or initiating the page via a QR code and/or RFID interaction located on the collectible and/or an encapsulation case of the collectible.

Option 1010 may be utilized to initiate a trade with a collectible (e.g., collectible 1002). Option 1011 may be utilized to initiate a grading process (e.g., a particular third-party physical grading process from one or a list of third-party grading processes). Option 1012 may be utilized to personalize a collectible such as change the colors displayed from multi-color LEDS or select a brightness, volume, contract, and/or experience set and/or experience preferences.

Option 1013 may be utilized to purchase a digital copy of a collectible such that a user may interact with a digital copy if the user on GUI 1001 if the user does not have a physical copy of the collectible. Option 1014 may be provided to upgrade a collectible. For example, enhanced experiences and functionality may be purchased for an upgrade fee.

Option 1015 may be utilized to sell (e.g., as well as buy) a physical and/or digital collectible from a marketplace. Option 1016 may be utilized to remove and/or destroy an NFT association from a collectible or destroy the NFT itself. Option 1017 may be provided to request to re-holder a holdered collectible (e.g., a grading holder). Option 1018 may be provided to buy the collectible shown as collectible 1002 (e.g., via a secondary marketplace or direct from a manufacturer). Collectibles may evolve in step 1019 and functionality may be enhanced if certain conditions are met and the consumer selects to evolve the collectible. A collectible may be auctioned with option 1020 and shipped/exported in step 1021. Additional functionality may be provided in step 1022. A collectible grouping (e.g., a playing deck of trading card game collectibles) may be created in step 1023. Multiple collectibles may be combined in order to unlock functionality and collectibles may only be combined a particular number of times (e.g., once). Persons skilled in the art will appreciate that if multiple collectible instances of the same collectible (e. g., multiple Michael Jordan trading cards) are provided that each one may be registered to a user account and each one may be provided with a separate GUI 1050 and that multiple instances of the same collectible may be combined to add functionality to each or to remove functionality from some (e.g., all but one) and add functionality to one or more (e.g., the one that did not have feature reduction). In doing so, for example, collecting multiple copies of a particular collectible is motivated and rewarded.

Option 1025 may be provided to authenticate a collectible by, for example, communicating with the collectible and an authorization system and comparing retrieved data from the collectible to data in the authorization system. A collectible may have functionality split or fractionalized across multiple collectibles in step 1026. For example, an upgrade grade may have 10 upgrades and that card may be split into 10 upgrades and used to combine with 10 different collectibles (or 10 times with one single collectible) to upgrade the collectible. Option 1027 may be provided to provide additional options to the user (e.g., donate to charity, make a custom experience and share it with friends).

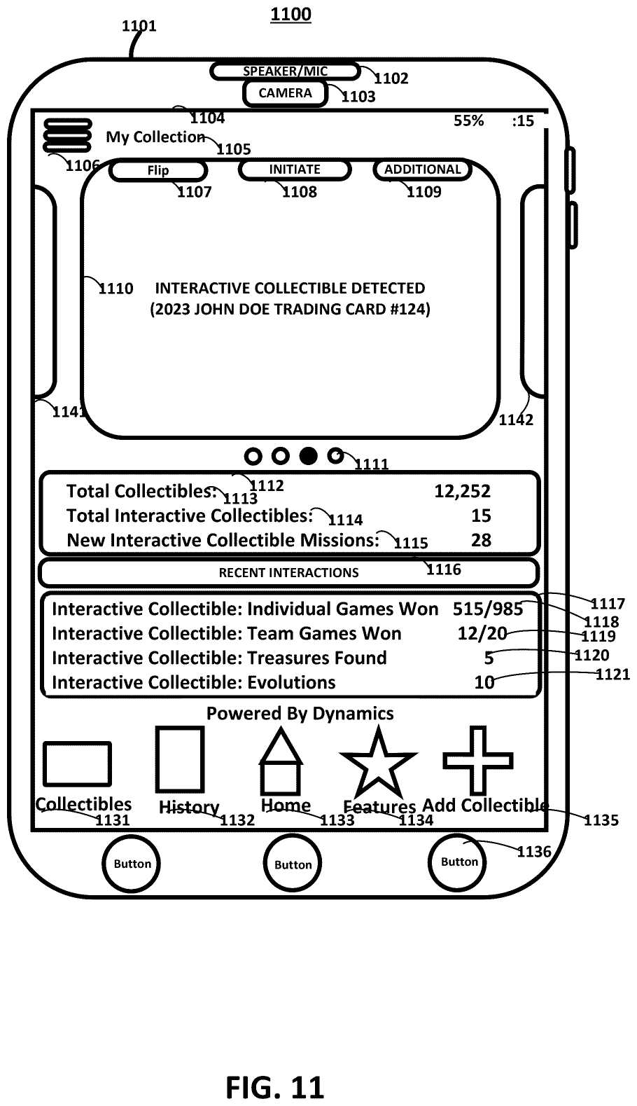

FIG. 11 shows device 1100 that may include housing 1101, speaker and/or microphone 1102, camera 1103, Graphical User Interface 1104 that may include options 1106, identifying indicia 1105, options 1107 (e.g., to flip an interactive collectible imaged in area 1110, option 1108 (e.g., to initiate detecting an electronic collectible and/or features of an electronic collectible, and additional options 1109. Multiple collectibles can be registered to an account for a user that may be accessible via device 1100 which may be a portable telephonic device. Collectible 1141 and Collectible 1142 may be selected on the screen and the selected collectible may be provided in selection identifier 1111. Additional information 1112 may be provided such as the total collectibles in an account via field 1113, the total interactive collectibles in a user account via field 1114, and the total new interactive collectible missions in field 1115. Collectibles may have missions (e.g., activities to perform) and those activities may have rewards (e.g., achievements to earn). Achievements may take the form of physical collectibles, digital collectibles, and/or downloadable content such as new downloadable experiences. Window 1117 may be provided and may include a ledger on certain activities such as recent interactions which may include field 1118 for individual collectible item games won, field 1119 for team collectible items games won, field 1120 for collectible items treasures found, and field 1121 for collectible evolutions completed. Persons skilled in the art will appreciate that treasures may be hidden in collectibles and users may have to perform certain actions that are either provided to the user or not provided to the user to find those treasures. For example, certain treasures (e.g., new experiences) may be unlocked upon a certain circumstance (e.g., a certain number of copies are brought into communication with one another) on certain dates (e.g., the anniversary of a championship win) and/or after a period of time (e.g., after a year, five years, ten years). Any type of parameter may be utilized for an achievement and/or treasure.

Option 1131 may be provided to direct a user to the user's collectible collection. Option 1132 may be provided to direct a user to the user's account history. Option 1133 may be provided to go to a home GUI. Option 1134 may be provided to show a user one or more features associated with the account. One or more buttons may be provided as button(s) 1136.

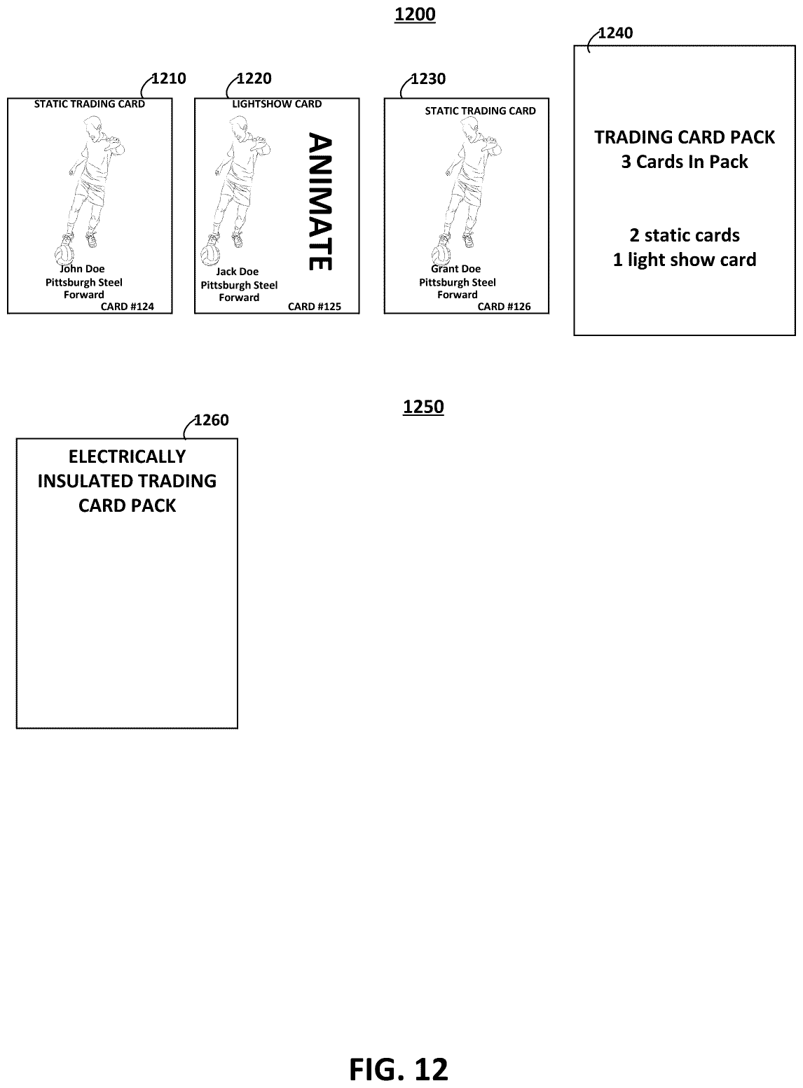

FIG. 12 may include a trading card pack 1240 that may include any number of collectibles such as three collectibles. Non-electronic collectible 1210 may be included in pack 1240. Electronic collectible 1220 may be included in pack 1240. Non-electronic trading card 1230 may be included in trading card pack 1240.

An electrically insulated trading card pack may be provided in step 1250 where the material of the sealed pack is provided such that communication signals cannot communicate with any electronic collectible in the pack. Metal decoy cards may be provided such that packs cannot be searched via metal detectors. The pack material (e.g., layers of material) may be non-transparent so that light cannot get in or out of the pack. Decoy cards may be placed as the first and last card of every pack, for example, such that mechanical buttons in an interactive trading card cannot be initiated.

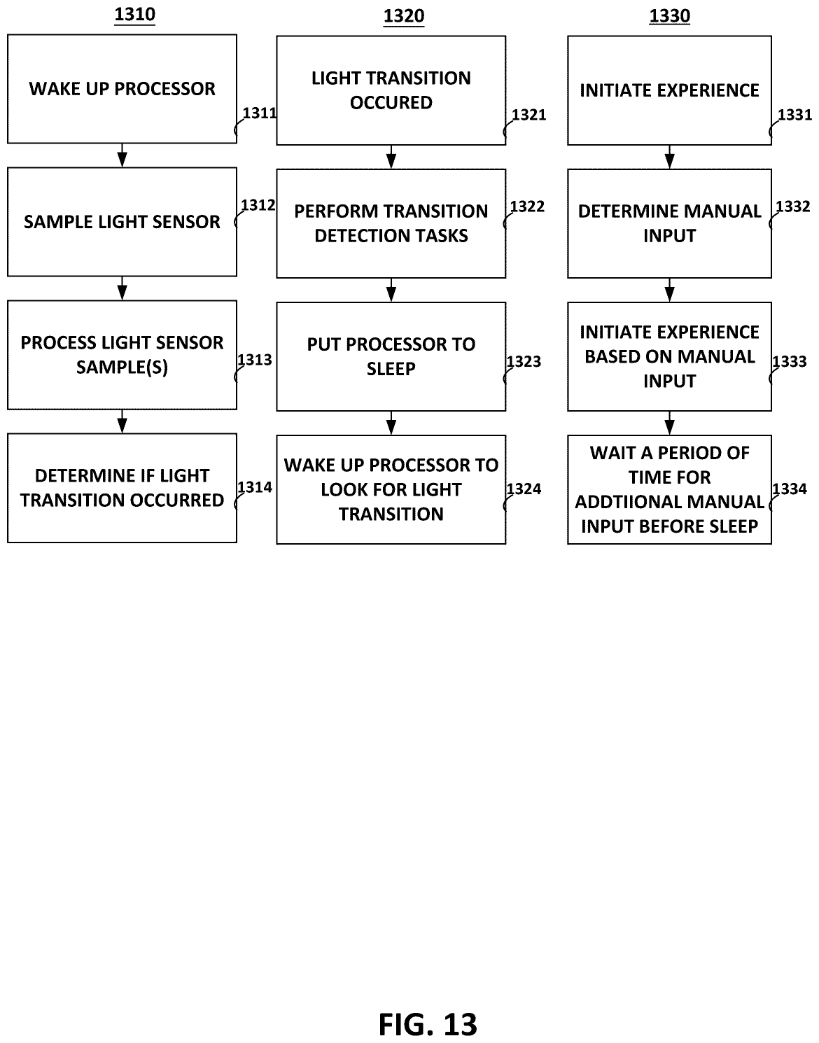

FIG. 13 shows flow chart 1310 that may include step 1311 in which a processor of a collectible is woken up from sleep mode. Step 1312 may be provided in which one or more light sensors are sampled. The samples may be processed in step 1313. A determination may be made in step 1314 if a light transition occurred.

Flow chart 1330 may be provided in which an experience is initiated in step 1331 (e.g., autonomously via autonomous sensing circuitry such as autonomous light sensing circuitry). A collectible may look for manual input in step 1332 and initiate an experience based on the manual input in section 1333. The collectible may then wait a period of time (e.g., at least 2 seconds, at least 5 seconds, at least 10 seconds, at least 20 seconds) for manual input to be recognized before putting the collectible to sleep. If the collectible is woken up from sleep, the collectible may determine its last operation and may resume functionality at that operation (e.g., waiting for the last manual input).

Process 1320 may be provided and may include step 1321 in which a light transition is determined to have occurred. Step 1322 may be provided in which transition detection tasks are performed (e.g., animations are played on a display). A processor may be put to sleep in step 1323 and the processor may be woken up again to look for light transitions in step 1324 (e.g., after a period of time such as at least 3 seconds, at least 4 seconds, at least 5 seconds).

Persons skilled in the art will appreciate that the present invention is not limited to only the embodiments described, and that features described in one embodiment may be used in a different embodiment. The present invention more generally involves security of both physical and digital transactions. Persons skilled in the art will also appreciate that the apparatus of the present invention may be implemented in other ways than those described herein. All such modifications are within the scope of the present invention, which is limited only by the claims that follow.

1. A trading card comprising:
a first trading card layer;
a second trading card layer having an obverse surface, a reverse surface, and a die-cut cavity, wherein said obverse surface is affixed to said first trading card layer, an electronics package including a battery, a light sensor, and an array of light emitting diodes is provided in said die-cut cavity;
a third trading card layer affixed to said reverse surface.

2. The trading card of claim 1, wherein said light sensor is aligned with an aperture on said first trading card layer.

3. The trading card of claim 1, wherein said light sensor is aligned with said first trading card layer and said first trading card layer comprises paper having an opacity where light sufficient to activate said light sensor is able to reach said light sensor through said paper.

4. The trading card of claim 1, wherein said light sensor is aligned with said first trading card layer and said first trading card layer comprises a polymer having an opacity where light sufficient to activate said light sensor is able to reach said light sensor through said paper.

5. The trading card of claim 1, wherein said trading card is a sports trading card.

6. The trading card of claim 1, wherein said trading card is a trading card game card.

7. The trading card of claim 1, wherein said electronics package includes a recharging antenna, processor, and at least 100 light emitting diodes.

8. A pack of trading cards comprising:
at least one static trading card that does not include any electronic components; and
a dynamic trading card, wherein said dynamic trading card includes:
a first trading card layer;
a second trading card layer having an obverse surface, a reverse surface, and a die-cut cavity, wherein said obverse surface is affixed to said first trading card layer, an electronics package including a battery, a light sensor, and an array of light emitting diodes is provided in said die-cut cavity;
a third trading card layer affixed to said reverse surface.

9. The trading card of claim 8, wherein said light sensor is aligned with an aperture on said first trading card layer.

10. The trading card of claim 8, wherein said light sensor is aligned with said first trading card layer and said first trading card layer comprises paper having an opacity where light sufficient to activate said light sensor is able to reach said light sensor through said paper.

11. The trading card of claim 8, wherein said light sensor is aligned with said first trading card layer and said first trading card layer comprises a polymer having an opacity where light sufficient to activate said light sensor is able to reach said light sensor through said paper.
